(19) United States
(12) Patent Application Publication
(10) Pub. No.: US 2023/0291933 A1
(43) Pub. Date: Sep. 14, 2023

(54) METHOD AND DEVICE FOR ENCODING/DECODING IMAGE BY SIGNALING GCI, AND COMPUTER-READABLE RECORDING MEDIUM IN WHICH BITSTREAM IS STORED

(71) Applicant: LG Electronics Inc., Seoul (KR)

(72) Inventors: Jung Hak NAM, Seoul (KR); Nae Ri PARK, Seoul (KR); Hyeong Moon JANG, Seoul (KR)

(21) Appl. No.: 17/924,829

(22) PCT Filed: May 20, 2021
(86) PCT No.: PCT/KR2021/006292

§ 371 Date: May 30, 2023

Related U.S. Application Data
(60) Provisional application No. 63/028,589, filed on May 22, 2020.

(51) Int. Cl. H04N 19/70; H04N 19/46; H04N 19/172

(52) U.S. Cl. CPC H04N 19/70; H04N 19/46; H04N 19/172

(57) ABSTRACT

An image encoding/decoding method and apparatus for signaling GCI and a method of transmitting a bitstream are provided. An image decoding method according to the present disclosure may comprise obtaining first information specifying whether to constrain application of a predetermined coding tool, obtaining second information specifying whether to apply the predetermined coding tool, and reconstructing a current picture based on the second information. A value of the second information may be determined based on a value of the first information, and the predetermined coding tool may comprise at least one of weighted prediction, explicit signaling of a scaling list for a transform coefficient or disabling of in-loop filtering at a virtual boundary.

### TECHNICAL FIELD

The present disclosure relates to an image encoding/decoding method and apparatus and, more particularly, to an image encoding/decoding method and apparatus and a computer-readable recording medium storing a bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus for improving encoding/decoding efficiency by signaling general constraint information (GCI).

Another object of the present disclosure is to provide a method of transmitting a bitstream generated by an image encoding method or apparatus according to the present disclosure.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

The technical problems solved by the present disclosure are not limited to the above technical problems and other technical problems which are not described herein will become apparent to those skilled in the art from the following description.

### Technical Solution

An image decoding method performed by an image decoding apparatus according to an aspect of the present disclosure may comprise obtaining first information specifying whether to constrain application of a predetermined coding tool, obtaining second information specifying whether to apply the predetermined coding tool, and reconstructing a current picture based on the second information. A value of the second information may be determined based on a value of the first information, and the predetermined coding tool may comprise at least one of weighted prediction, explicit signaling of a scaling list for a transform coefficient or disabling of in-loop filtering at a virtual boundary.

In the image decoding method of the present disclosure, the second information may have a value specifying that the predetermined coding tool is not applied, based on the first information specifying that application is constrained.

In the image decoding method of the present disclosure, the first information may be obtained from a syntax structure for signaling general constraint information.

In the image decoding method of the present disclosure, the second information may be obtained from a sequence parameter set (SPS).

An image decoding apparatus according to another aspect of the present disclosure may comprise a memory and at least one processor. The at least processor may obtain first information specifying whether to constrain application of a predetermined coding tool, obtain second information specifying whether to apply the predetermined coding tool, and reconstruct a current picture based on the second information. A value of the second information may be determined based on a value of the first information, and the predetermined coding tool may comprise at least one of weighted prediction, explicit signaling of a scaling list for a transform coefficient or disabling of in-loop filtering at a virtual boundary.

An image encoding method performed by an image encoding apparatus according to another aspect of the present disclosure may comprise encoding first information specifying whether to constrain application of a predetermined coding tool, encoding second information specifying whether to apply the predetermined coding tool, and encoding a current picture in a current video sequence based on the second information. A value of the second information may be determined based on a value of the first information, and the predetermined coding tool may comprise at least one of weighted prediction, explicit signaling of a scaling list for a transform coefficient or disabling of in-loop filtering at a virtual boundary.

In the image encoding method of the present disclosure, the second information may have a value specifying that the predetermined coding tool is not applied, based on the first information specifying that application is constrained.

In the image encoding method of the present disclosure, the first information may be encoded in a syntax structure for signaling general constraint information.

In the image encoding method of the present disclosure, the second information may be encoded in a sequence parameter set (SPS).

A transmission method according to another aspect of the present disclosure may transmit the bitstream generated by the image encoding apparatus or the image encoding method of the present disclosure.

A computer-readable recording medium according to another aspect of the present disclosure may store the bitstream generated by the image encoding apparatus or the image encoding method of the present disclosure.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an image encoding/decoding method and apparatus for improving encoding/decoding efficiency by signaling general constraint information (GCI).

Also, according to the present disclosure, it is possible to provide a method of transmitting a bitstream generated by an image encoding method or apparatus according to the present disclosure.

Also, according to the present disclosure, it is possible to provide a recording medium storing a bitstream generated by an image encoding method or apparatus according to the present disclosure.

Also, according to the present disclosure, it is possible to provide a recording medium storing a bitstream received, decoded and used to reconstruct an image by an image decoding apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically showing a video coding system, to which an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an embodiment of the present disclosure is applicable.

FIG. 4 is a view showing an example of a schematic picture decoding procedure, to which embodiment(s) of the present disclosure is applicable.

FIG. 5 is a view showing an example of a schematic picture encoding procedure, to which embodiment(s) of the present disclosure is applicable.

FIG. 6 is a view illustrating an example of a syntax structure for signaling conventional general constraint information.

FIG. 7 is a view showing an example of a syntax structure for signaling information indicating whether to constrain weighted prediction as general constraint information.

FIG. 8 is a view illustrating operation of an image encoding apparatus according to an embodiment described with reference to FIG. 7.

FIG. 9 is a view illustrating operation of an image decoding apparatus according to an embodiment described with reference to FIG. 7.

FIG. 10 is a view illustrating an example of a syntax structure for signaling information specifying whether to constrain explicit signaling of a scaling list as general constraint information of the present disclosure.

FIG. 11 is a view illustrating operation of the image encoding apparatus according to the embodiment described with reference to FIG. 10.

FIG. 12 is a view illustrating operation of the image decoding apparatus according to the embodiment described with reference FIG. 10.

FIG. 13 is a view illustrating an example of a syntax structure for signaling information specifying whether to constrain disabling of in-loop filtering at a virtual boundary as general constraint information of the present disclosure.

FIG. 14 is a view illustrating operation of the image encoding apparatus according to the embodiment described with reference to FIG. 13.

FIG. 15 is a view illustrating operation of the image decoding apparatus according to the embodiment described with reference FIG. 13.

FIG. 16 is a view illustrating an example of a syntax structure for signaling information specifying whether to constrain entropy coding synchronization as general constraint information of the present disclosure.

FIG. 17 is a view illustrating an example of a syntax structure for signaling information specifying whether to constrain use of a long term reference picture (LTRP) as general constraint information of the present disclosure.

FIG. 18 is a view showing a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The “luma block of the current block” may be expressed by including an explicit description of a luma component block, such as “luma block” or “current luma block”. The “chroma block of the current block” may be expressed by including an explicit description of a chroma component block, such as “chroma block” or “current chroma block”.

In the present disclosure, “A or B” may mean “only A”, “only B” or “both A and B”. In other words, in the present disclosure, “A or B” may be interpreted as “A and/or B”. For example, in the present disclosure, “A, B or C” may mean “only A, “only B”, “only C” or “any combination of A, B and C”.

A slash (/) or comma used in the present disclosure may mean “and/or”. For example, “A/B” may mean “A and/or B”. Therefore, “A/B” may mean “only A”, “only B” or “both A and B”. For example, “A, B, C” may mean “A, B or C”.

In the present disclosure, “at least one of A and B” may mean “only A”, “only B” or “both A and B”. In addition, in the disclosure, “at least one of A or B” or “at least one of A and/or B” may be interpreted as being the same as “at least one of A and B”.

In addition, in the present disclosure, “at least one of A, B and C” may mean “only A”, “only B”, “only C” or “any combination of A, B and C”. In addition, in the disclosure, “at least one of A, B or C” or “at least one of A, B and/or C” may be interpreted as being the same as “at least one of A, B and C”.

In addition, parentheses used in the present disclosure may mean “for example”. Specifically, when “prediction (intra prediction” is described, “intra prediction” may be proposed as an example of “prediction”. In other words, “prediction” of the present disclosure is not limited to “intra prediction” and “intra prediction” may be proposed as an example of “prediction”. In addition, even when “prediction (that is, intra prediction)” is described, “intra prediction” may be proposed as an example of “prediction”.

In the present disclosure, technical features individually described in one drawing may be implemented individually or simultaneously.

Overview of Video Coding System

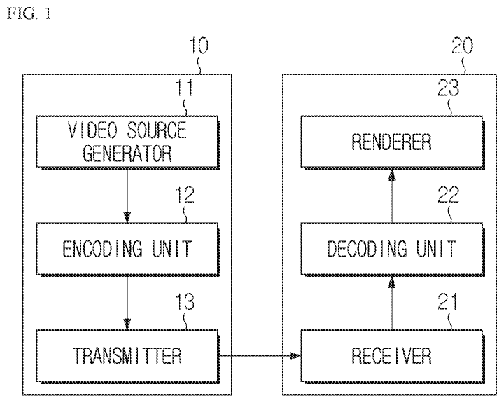

FIG. 1 is a view showing a video coding system according to the present disclosure.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

Overview of Image Encoding Apparatus

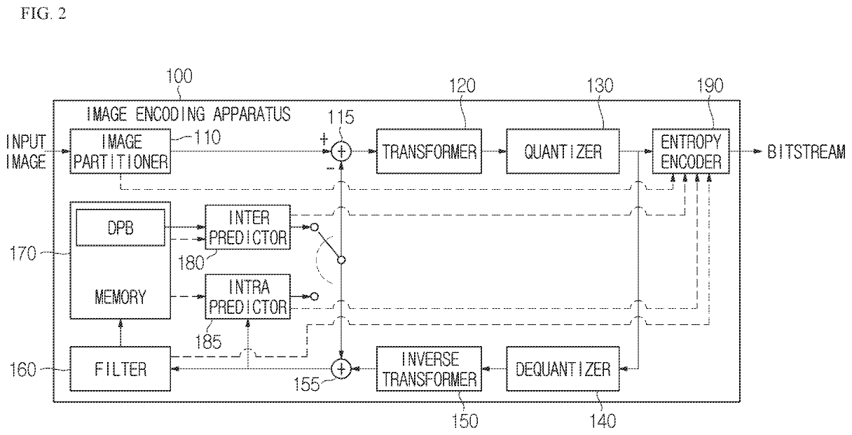

FIG. 2 is a view schematically showing an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content video/image coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loeve transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

Meanwhile, in a picture encoding and/or reconstruction process, luma mapping with chroma scaling (LMCS) may be applied.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

Overview of Image Decoding Apparatus

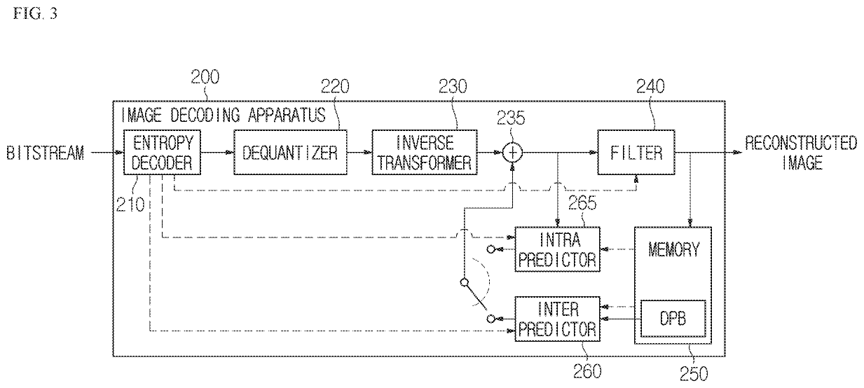

FIG. 3 is a view schematically showing an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

Meanwhile, in a picture decoding process, luma mapping with chroma scaling (LMCS) may be applied.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

The quantizer of the encoding apparatus may derive quantized transform coefficients by applying quantization to transform coefficients, and the dequantizer of the encoding apparatus or the dequantizer of the decoding apparatus may derive transform coefficients by applying dequantization to the quantized transform coefficients. In video coding, a quantization rate may be changed and a compression rate may be adjusted using the changed quantization rate. From an implementation point of view, a quantization parameter (QP) may be used instead of directly using the quantization rate in consideration of complexity. For example, a quantization parameter of an integer value from 0 to 63 may be used, and each quantization parameter set may correspond to an actual quantization rate. A quantization parameter QP_{Y} for a luma component (luma sample) and a quantization parameter QP_{C} for a chroma component (chroma sample) may be differently set.

In the quantization process, a transform coefficient C may be input and divided by a quantization rate Qstep, and a quantized transform coefficient C′ may be derived based on this. In this case, the quantization rate may be multiplied by a scale in consideration of computational complexity to form an integer and a shift operation may be performed by a value corresponding to the scale value. A quantization scale may be derived based on a product of the quantization rate and the scale value. That is, the quantization scale may be derived according to the QP. The quantization scale may be applied to the transform coefficient and the quantized transform coefficient C′ may be derived based on this.

A dequantization process is an inverse process of the quantization process, and the quantized transform coefficient C′ may be multiplied by the quantization rate Qstep, and a reconstructed transform coefficient C″ may be derived based on this. In this case, a level scale may be derived according to the quantization parameter, the level scale may be applied to the quantized transform coefficient C″, and the reconstructed transform coefficient C″ may be derived based on this. The reconstructed transform coefficient C″ may be slightly different from an original transform coefficient C due to loss in a transform and/or quantization process. Accordingly, even in the encoding apparatus, dequantization may be performed in the same manner as in the decoding apparatus.

Meanwhile, adaptive frequency weighting quantization technology for adjusting quantization strength according to the frequency may be applied. Adaptive frequency weighting quantization technology may correspond to a method of differently applying the quantization strength according to the frequency. In adaptive frequency weighting quantization, the quantization strength may be differently applied according to the frequency using a predefined quantization scaling matrix. That is, the above-described quantization/dequantization process may be performed further based on the quantization scaling matrix.

For example, a different quantization scaling matrix may be used depending on the size of a current block and/or whether a prediction mode applied to the current block to generate a residual signal of the current block is inter prediction or intra prediction. The quantization scaling matrix may be referred to as a quantization matrix or a scaling matrix. The quantization scaling matrix may be predefined. In addition, for frequency adaptive scaling, frequency quantization scaling information for the quantization scaling matrix may be constructed/encoded in the encoding apparatus and signalled to the decoding apparatus. The frequency quantization scaling information may be referred to as quantization scaling information. The frequency quantization scale information may include scaling list data scaling list data.

The quantization scaling matrix may be derived based on the scaling list data. In addition, the frequency quantization scale information may include present flag information specifying whether the scaling list data is present. In addition, when the scaling list data is signalled at a high level (e.g., SPS), information specifying whether the scaling list data is modified at a lower level (e.g., PPS, APS or slice header, etc.) may be further included.

General Video/Image Coding Procedure

In video/image coding, a picture configuring an video/image may be encoded/decoded according to a decoding order. A picture order corresponding to an output order of the decoded picture may be set differently from the decoding order, and, based on this, not only forward prediction but also backward prediction may be performed during inter prediction.

FIG. 4 shows an example of a schematic picture decoding procedure, to which embodiment(s) of the present disclosure is applicable.

Each procedure shown in FIG. 4 may be performed by the image decoding apparatus of FIG. 3. For example, step S410 may be performed by the entropy decoder 210, step S420 may be performed by a prediction unit including the prediction units 265 and 260, step S430 may be performed by a residual processor 220 and 230, step S440 may be performed by the adder 235, and step S450 may be performed by the filter 240. Step S410 may include the information decoding procedure described in the present disclosure, step S420 may include the inter/intra prediction procedure described in the present disclosure, step S430 may include a residual processing procedure described in the present disclosure, step S440 may include the block/picture reconstruction procedure described in the present disclosure, and step S450 may include the in-loop filtering procedure described in the present disclosure.

Referring to FIG. 4, the picture decoding procedure may schematically include a procedure (S410) for obtaining video/image information (through decoding) from a bitstream, a picture reconstruction procedure (S420 to S440) and an in-loop filtering procedure (S450) for a reconstructed picture. The picture reconstruction procedure may be performed based on prediction samples and residual samples obtained through inter/intra prediction (S420) and residual processing (S430) (dequantization and inverse transform of the quantized transform coefficient) described in the present disclosure. A modified reconstructed picture may be generated through the in-loop filtering procedure for the reconstructed picture generated through the picture reconstruction procedure. In this case, the modified reconstructed picture may be output as a decoded picture, stored in a decoded picture buffer (DPB) of a memory 250 and used as a reference picture in the inter prediction procedure when decoding the picture later. The in-loop filtering procedure (S450) may be omitted. In this case, the reconstructed picture may be output as a decoded picture, stored in a DPB of a memory 250, and used as a reference picture in the inter prediction procedure when decoding the picture later. The in-loop filtering procedure (S450) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, after the deblocking filtering procedure is applied to the reconstructed picture, the ALF procedure may be performed. This may be similarly performed even in the encoding apparatus.

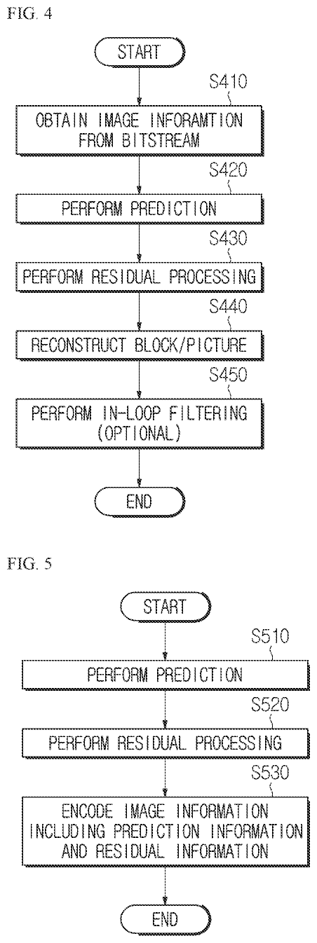

FIG. 5 shows an example of a schematic picture encoding procedure, to which embodiment(s) of the present disclosure is applicable.

Each procedure shown in FIG. 5 may be performed by the image encoding apparatus of FIG. 2. For example, step S510 may be performed by the prediction units 185 and 180, step S520 may be performed by a residual processor 115, 120 and 130, and step S530 may be performed in the entropy encoder 190. Step S510 may include the inter/intra prediction procedure described in the present disclosure, step S520 may include the residual processing procedure described in the present disclosure, and step S530 may include the information encoding procedure described in the present disclosure.

Referring to FIG. 5, the picture encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture, as described with respect to FIG. 2. The encoding apparatus may derive (modified) residual samples from a quantized transform coefficient through the dequantizer 140 and the inverse transformer 150, and generate the reconstructed picture based on the prediction samples which are output of step S510 and the (modified) residual samples. The reconstructed picture generated in this way may be equal to the reconstructed picture generated in the decoding apparatus. The modified reconstructed picture may be generated through the in-loop filtering procedure for the reconstructed picture. In this case, the modified reconstructed picture may be stored in the decoded picture buffer or a memory 170, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the decoding apparatus may perform the in-loop filtering procedure using the same method as the encoding apparatus based on the filtering related information.

Through such an in-loop filtering procedure, noise occurring during video/image coding, such as blocking artifact and ringing artifact, may be reduced and subjective/objective visual quality may be improved. In addition, by performing the in-loop filtering procedure in both the encoding apparatus and the decoding apparatus, the encoding apparatus and the decoding apparatus may derive the same prediction result, picture coding reliability may be increased and the amount of data to be transmitted for picture coding may be reduced.

As described above, the picture reconstruction procedure may be performed not only in the image decoding apparatus but also in the image encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. On the other hand, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component and the methods and embodiments of the present disclosure are applicable to both the luma component and the chroma component unless explicitly limited in the present disclosure.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

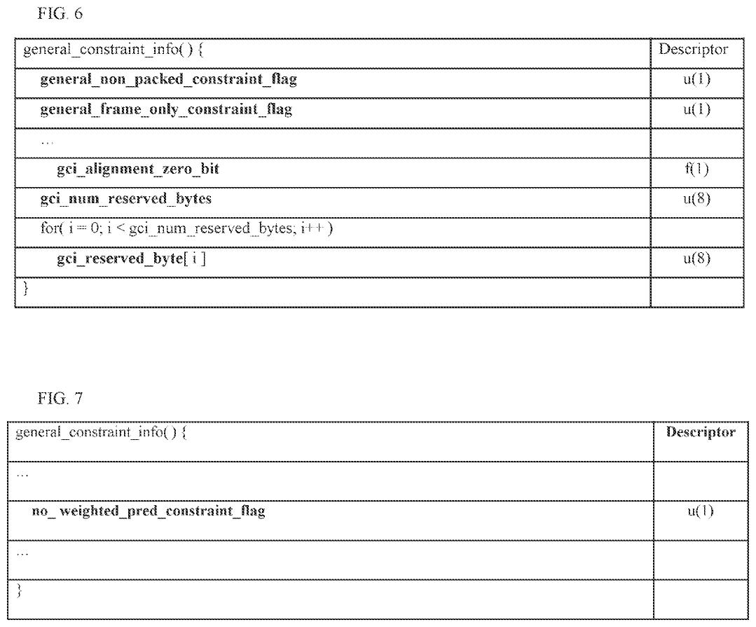

FIG. 6 is a view illustrating an example of a syntax structure for signaling conventional general constraint information. In VVC, a general constraint flag for controlling a coding tool or function for a profile, layer or level may exist.

Referring to FIG. 6, a bitstream may include, for example, information such as general_non_packed_constraint_flag or general_frame_only_constraint_flag in a general_constraint_info( ) syntax structure as general constraint information.

For example, as general constraint information, information (e.g., general_non_packed_constraint_flag) specifying whether to constrain a frame packing arrangement SEI message may be signaled in a bitstream of OlsInScope. general_non_packed_constraint_flag of a first value (e.g., 1) may specify that the frame packing arrangement SEI message present in the bitstream of OlsInScope is not present. general_non_packed_constraint_flag of a second value (e.g., 0) may specify that the constraint is not imposed.

In addition, for example, as general constraint information, information (e.g., general_frame_only_constraint_flag) specifying whether to constrain a frame of OlsInScope may be signaled. general_frame_only_constraint_flag of a first value (e.g., 1) may specify that a constraint is imposed such that OlsInS cope delivers a picture specifying a frame. general_frame_only_constraint_flag of a second value (e.g., 0) may specify that the constraint is not imposed. That is, when general_frame_only_constraint_flag is a second value, the picture delivered by OlsinScope may or may not specify a frame. In the above, OlsinScope may mean an output layer set included in the bitstream.

General constraint information is not limited to general_non_packed_constraint_flag and general_frame_only_constraint_flag described with reference to FIG. 6, and the other general constraint information may be signaled. However, a conventional syntax structure for signaling general constraint information has a problem that constraint on various coding means is not sufficiently supported.

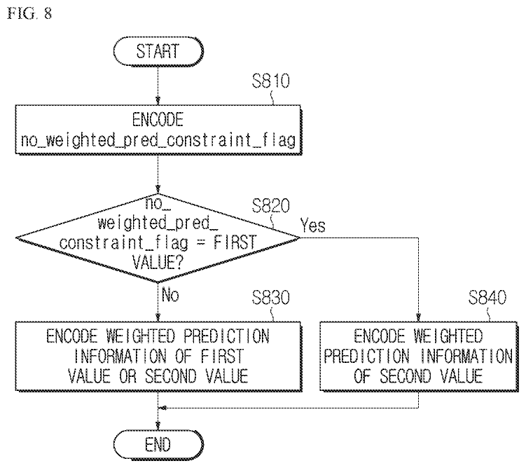

FIG. 7 is a view illustrating an example of a syntax structure for signaling information specifying whether to constrain weighted prediction as general constraint information of the present disclosure.

As described above, a predicted block for a current block may be derived based on motion information derived according to a prediction mode. The predicted block may include prediction samples (prediction sample array) of the current block. When a motion vector of the current block specifies a fractional sample unit, an interpolation procedure may be performed. Therefore, prediction samples of the current block may be derived based on reference samples of a fractional sample unit in a reference picture.

When affine inter prediction is applied to the current block, prediction samples may be generated based on a sample/subblock unit motion vector (MV). When bi-prediction is applied, the prediction samples may be derived based on L0 prediction (that is, prediction using MVL0 and a reference picture in reference picture list L0) and the prediction samples may be derived based on L1 prediction (that is, prediction using MVL1 and a reference picture in reference picture list L1). In addition, the prediction samples derived through a weighted sum or a weighted average of the derived prediction samples (according to the phase) may be used as the prediction samples of the current block. In the case where bi-prediction is applied, when a reference picture used for L0 prediction and a reference picture used for L1 prediction are located in different temporal directions based on a current picture (that is, when it corresponds to bi-prediction and bidirectional prediction), this may be referred to as true bi-prediction. Based on the derived prediction samples, reconstructed samples and a reconstructed picture may be generated.

In inter prediction, weighted sample prediction may be used. Weighted sample prediction may be referred to as weighted prediction. Weighted prediction may be applied when a slice type of a current slice in which a current block (e.g., CU) is a P slice or a B slice. That is, weighted prediction may be used not only when bi-prediction is applied but also when uni-prediction is applied. For example, weighted prediction may be determined based on weightedPredFlag. A value of weightedPredFlag may be determined based on signaled pps_weighted_pred_flag (in case of a P slice) or pps_weighted_bipred_flag (in case of a B slice). More specifically, weightedPredFlag specifying whether weighted prediction is applied for the current block may be derived as a pps_weighted_pred_flag value in the case of the P slice and may be derived as a pps_weighted_bipred_flag value in the case of the B slice. In the above, pps_weighted_pred_flag may be information specifying whether weighted prediction is applied to the P slice, and pps_weighted_bipred_flag may be information specifying whether explicit weighted prediction is applied to the B slice. pps_weighted_pred_flag and pps_weighted_bipred_flag may be included and signaled in a parameter set (e.g., a picture parameter set (PPS) of a picture level. In the present disclosure, explicit weighted prediction may mean weighted prediction when information on a weight used for weighted prediction is explicitly signaled through a bitstream. According to an embodiment of the present disclosure, constraint information of weighted prediction may be signaled as general constraint information.

Referring to FIG. 7, information (e.g., no_weighted_pred_constraint_flag) specifying whether to constrain weighted prediction may be signaled. In this case, information specifying whether to constrain weighted prediction may be included and signaled in a general_constraint_info( ) syntax structure for signaling general constraint information.

According to the present embodiment, no_weighted_pred_constraint_flag of a first value (e.g., 1) may mean that constraint is imposed such that sps_weighted_pred_flag and sps_weighted_bipred_flag have a value of 0. In addition, no_weighted_pred_constraint_flag of a second value (e.g., 0) may mean that the constraint is not imposed. In the above, sps_weighted_pred_flag is information signaled at a high level (e.g., SPS), and may be an example of information specifying whether weighted prediction is applied. For example, sps_weighted_pred_flag of a first value (e.g., 1) may specify that weighted prediction is applicable to a P slice referencing an SPS, and sps_weighted_pred_flag of a second value (e.g., 0) may specify that weighted prediction is not applied to the P slice referencing the SPS. In addition, sps_weighted_bipred_flag may be information signaled at a high level (e.g., SPS) and may be an example of information specifying whether to apply explicit weighted prediction. For example, sps_weighted_bipred_flag of a first value (e.g., 1) may specify that explicit weighted prediction is applicable to a B slice referencing an SPS and sps_weighted_bipred_flag of a second value (e.g., 0) may specify that explicit weighted prediction is not applied to the B slice referencing the SPS. As described above, general constraint information may be included and signaled in a general_constraint_info( ) syntax structure. The general_constraint_info( ) syntax structure is present in a profile tier level (PTL) syntax structure, and information on additional constraints or restrictions for a specific profile, tier and level may be provided.

FIG. 8 is a view illustrating operation of the image encoding apparatus according to the embodiment described with reference to FIG. 7. In FIG. 8, weighted prediction information may include at least one of uni-directional weighted prediction information or bi-directional weighted prediction information. The uni-directional weighted prediction information may correspond to information specifying whether weighted prediction is applicable to a P slice. For example, the uni-directional weighted prediction information may correspond to a flag such as sps_weighted_pred_flag or pps_weighted_pred_flag. The bi-directional weighted prediction information may correspond to information specifying whether explicit weighted prediction is applicable to a B slice. For example, the bi-directional weighted prediction information may correspond to a flag such as sps_weighted_bipred_flag or pps_weighted_bipred_flag. The weighted prediction information may be signaled at at least one of a sequence level or a picture level. For example, the weighted prediction information may be included and signaled in at least one of a sequence parameter set (SPS) or a picture parameter set (PPS).

Referring to FIG. 8, the image encoding apparatus may encode no_weighted_pred_constraint_flag (S810). The image encoding apparatus may determine whether constraint is imposed on weighted prediction and encode no_weighted_pred_constraint_flag accordingly. When constraint is imposed on weighted prediction, the image encoding apparatus may encode no_weighted_pred_constraint_flag of a first value (e.g., 1). Alternatively, when constraint is not imposed on weighted prediction, the image encoding apparatus may encode no_weighted_pred_constraint_flag of a second value (e.g., 0). The image encoding apparatus may encode no_weighted_pred_constraint_flag as general constraint information in a general_constraint_info( ) syntax structure. For example, the image encoding apparatus may set constraint of weighted prediction through signaling of no_weighted_pred_constraint_flag even when weighted prediction is applied to a current profile, tier and level. Therefore, more various encoding environments may be set.

The image encoding apparatus determines the value of no_weighted_pred_constraint_flag (S820), and, when the value is a second value (e.g., 0) (S820-No), the image encoding apparatus may encode weighted prediction information of a first value (e.g., 1) or a second value (e.g., 0) (S830). When the value of no_weighted_pred_constraint_flag is a first value (e.g., 1) (S820-Yes), the image encoding apparatus may encode weighted prediction information of a second value (e.g., 0) (S840). The image encoding apparatus may encode, for example, sps_weighted_pred_flag and sps_weighted_bipred_flag in the SPS.

When weighted prediction information (sps_weighted_pred_flag or sps_weighted_bipred_flag) is a first value (e.g., 1), the image encoding apparatus may encode additional information related to weighted prediction (not shown). When weighted prediction information (sps_weighted_pred_flag or sps_weighted_bipred_flag) is a second value (e.g., 0), the image encoding apparatus may skip signaling of additional information related to weighted prediction (not shown). The image encoding apparatus may or may not apply weighted prediction and/or explicit weighted prediction based on sps_weighted_pred_flag, sps_weighted_bipred_flag and/or additional information related to weighted prediction, thereby performing encoding with respect to the current picture included in the current sequence.

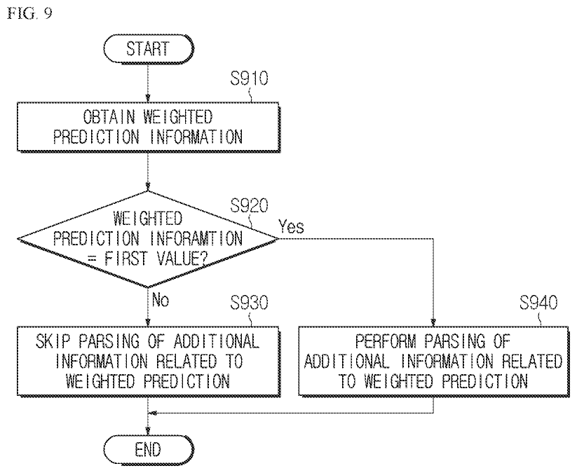

FIG. 9 is a view illustrating operation of the image decoding apparatus according to the embodiment described with reference FIG. 7.

Referring to FIG. 9, the image decoding apparatus may obtain weighted prediction information from a bitstream (S910). In this case, the weighted prediction information may be encoded by the method described with reference to FIG. 8.

The image decoding apparatus may determine whether the weighted prediction information is a first value (e.g., 1) (S920). When the weighted prediction information is a first value (e.g., 1) (S920-Yes), the image decoding apparatus may parse additional information related to weighted prediction (S940). In this case, the image decoding apparatus may reconstruct a current picture (not shown), by applying weighted prediction to a P slice or applying explicit weighted prediction to a B slice, based on additional information related to weighted prediction.

When the weighted prediction information is a second value (e.g., 0) (S920-No), the image decoding apparatus may skip parsing of additional information related to weighted prediction (S930). In addition, the image decoding apparatus may reconstruct a current picture (not shown) without applying weighted prediction and explicit weighted prediction.

The weighted prediction information (sps_weighted_pred_flag or sps_weighted_bipred_flag) received by the image decoding apparatus is encoded by the method described with reference to FIG. 8. That is, the image decoding apparatus receives the weighted prediction information (sps_weighted_pred_flag or sps_weighted_bipred_flag) encoded by the image encoding apparatus based on no_weighted_pred_constraint_flag. Accordingly, the image decoding apparatus may obtain the weighted prediction information (sps_weighted_pred_flag or sps_weighted_bipred_flag) encoded as an accurate value according to the present disclosure without determining whether no_weighted_pred_constraint_flag is a first value (e.g., 1).

However, operation of the image decoding apparatus is not limited to the above example, and the image decoding apparatus may infer the value of the weighted prediction information (sps_weighted_pred_flag or sps_weighted_bipred_flag) based on no_weighted_pred_constraint_flag. For example, the image decoding apparatus may infer the weighted prediction information (sps_weighted_pred_flag or sps_weighted_bipred_flag) as a second value (e.g., 0) when the value of no_weighted_pred_constraint_flag is a first value (e.g., 1).

In addition, although not shown in FIG. 9, the image decoding apparatus may obtain no_weighted_pred_constraint_flag from a bitstream. The image decoding apparatus may infer the weighted prediction information (sps_weighted_pred_flag or sps_weighted_bipred_flag) as described above based on the obtained no_weighted_pred_constraint_flag, and may efficiently perform initialization of the apparatus by including whether to apply a module related to weighted prediction. For example, the image decoding apparatus may initialize the apparatus such that weighted prediction is constrained based on no_weighted_pred_constraint_flag, even when a current profile, tier and level allows weighted prediction. Therefore, more various encoding environments may be set.

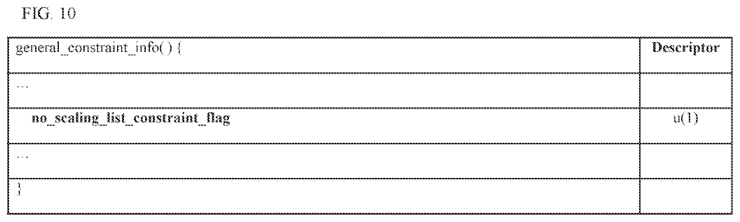

FIG. 10 is a view illustrating an example of a syntax structure for signaling information specifying whether to constrain explicit signaling of a scaling list as general constraint information of the present disclosure.

According to another embodiment of the present disclosure, constraint information of explicit signaling of the scaling list may be signaled as general constraint information.

Referring to FIG. 10, information (e.g., no_scaling_list_constraint_flag) specifying whether to constrain use of the explicit scaling list may be signaled. In this case, the information specifying whether to constrain use of the explicit scaling list may be included and signaled in a general_constraint_info( ) syntax structure for signaling general constraint information.

According to the present embodiment, no_scaling_list_constraint_flag of a first value (e. g., 1) may mean that constraint is imposed such that sps_explicit_scaling_list_enabled_flag has a value of 0. In addition, no_scaling_list_constraint_flag of a second value (e.g., 0) may mean that the constraint is not imposed. In the above, sps_explicit_scaling_list_enabled_flag is information signaled at a high level (e.g., SPS), and may be an example of information specifying whether to use the explicit scaling list.

For example, sps_explicit_scaling_list_enabled_flag of a first value (e.g., 1) may specify that, when decoding a slice, use of the explicit scaling list signaled at an adaptation parameter set (APS) is enabled for a coded layer video sequence (CLVS) in a scaling (dequantization) process for a transform coefficient, and sps_explicit_scaling_list_enabled_flag of a second value (e.g., 0) may specify that, when decoding a slice, use of the explicit scaling list signaled at the APS is disabled for the coded layer video sequence (CLVS) in the scaling (dequantization) process for the transform coefficient. When the explicit scaling list is used, the scaling matrix used for the scaling process for the transform coefficient may be derived based on a scaling list included and explicitly signaled in a bitstream (e.g., scaling list APS). When the explicit scaling list is not used, the scaling matrix used for the scaling process for the transform coefficient may be derived by a predetermined procedure. The predetermined procedure may be a procedure predetermined between the image encoding apparatus and the image decoding apparatus. Alternatively, for example, the scaling matrix may be derived using a value predetermined between the image encoding apparatus and the image decoding apparatus. As described above, general constraint information may be included and signaled in a general_constraint_info( ) syntax structure. The general_constraint_info( ) syntax structure is present in a profile tier level (PTL) syntax structure and information on additional constraints or restrictions for a specific profile, tier and level may be provided.

FIG. 11 is a view illustrating operation of the image encoding apparatus according to the embodiment described with reference to FIG. 10.

Referring to FIG. 11, the image encoding apparatus may encode no_scaling_list_constraint_flag (S1110). The image encoding apparatus may determine whether to impose a constraint on use of the explicit scaling list and encode no_scaling_list_constraint_flag accordingly. When the constraint is imposed on use of the explicit scaling list, the image encoding apparatus may encode no_scaling_list_constraint_flag of a first value (e.g., 1). Alternatively, When the constraint is not imposed on use of the explicit scaling list, the image encoding apparatus may encode no_scaling_list_constraint_flag of a second value (e.g., 0). The image encoding apparatus may encode no_scaling_list_constraint_flag as general constraint information in the general_constraint_info( ) syntax structure. For example, the image encoding apparatus may set constraint on use of the explicit scaling list through signaling of no_weighted_pred_constraint_flag even when a current profile, tier and level allows use of the explicit scaling list. Therefore, more various encoding environments may be set.

The image encoding apparatus determines the value of no_weighted_pred_constraint_flag (S1120), and, when the value is a second value (e.g., 0) (S1120-No), the image encoding apparatus may encode sps_explicit_scaling_list_enabled_flag of a first value (e.g., 1) or a second value (e.g., 0) (S1130). When the value of no_scaling_list_constraint_flag is a first value (e.g., 1) (S1120-Yes), the image encoding apparatus may encode sps_explicit_scaling_list_enabled_flag of a second value (e.g., 0) (S1140). The image encoding apparatus may encode, for example, sps_explicit_scaling_list_enabled_flag in the SPS.

When sps_explicit_scaling_list_enabled_flag is a first value (e.g., 1), the image encoding apparatus may encode additional information related to the explicit scaling list (not shown). When sps_explicit_scaling_list_enabled_flag is a second value (e.g., 0), the image encoding apparatus may skip signaling of the additional information related to the explicit scaling list (not shown). The image encoding apparatus may or may not use the explicit scaling list based on sps_explicit_scaling_list_enabled_flag and/or the additional information related to the explicit scaling list, thereby performing encoding with respect to the current picture included in the current sequence.

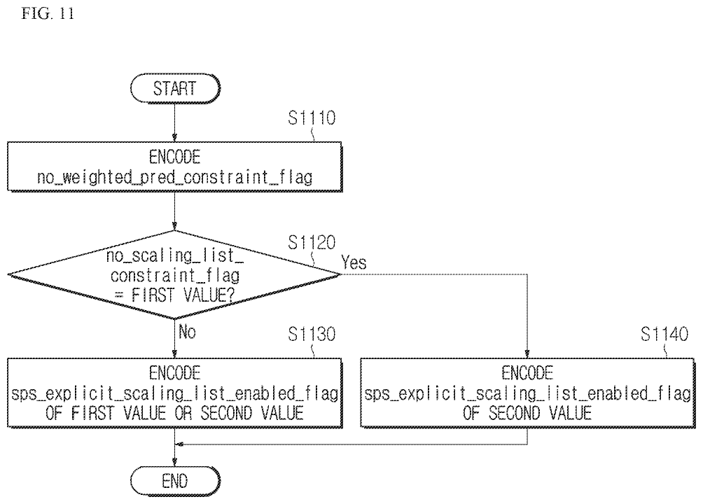

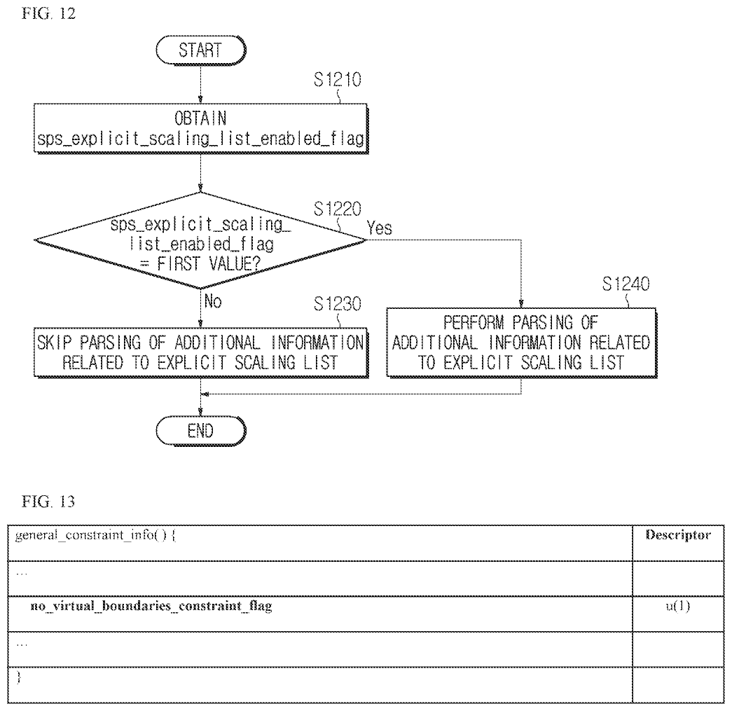

FIG. 12 is a view illustrating operation of the image decoding apparatus according to the embodiment described with reference FIG. 10.

Referring to FIG. 12, the image decoding apparatus may obtain sps_explicit_scaling_list_enabled_flag from a bitstream (S1210). In this case, sps_explicit_scaling_list_enabled_flag may be encoded by the method described with reference to FIG. 11.

The image decoding apparatus may determine whether sps_explicit_scaling_list_enabled_flag is a first value (e.g., 1) (S1220). When sps_explicit_scaling_list_enabled_flag is a first value (e.g., 1) (S1220-Yes), the image decoding apparatus may parse additional information related to the explicit scaling list (S1240). In this case, the image decoding apparatus may reconstruct a current picture (not shown), by using the explicit scaling list, based on the additional information related to the explicit scaling list. When sps_explicit_scaling_list_enabled_flag is a second value (e.g., 0) (S1220-No), the image decoding apparatus may skip parsing of additional information related to the explicit scaling list (S1230). In addition, the image decoding apparatus may reconstruct a current picture (not shown) without using the explicit scaling list.

sps_explicit_scaling_list_enabled_flag received by the image decoding apparatus is encoded by the method described with reference to FIG. 11. That is, the image decoding apparatus receives sps_explicit_scaling_list_enabled_flag encoded by the image encoding apparatus based on no_scaling_list_constraint_flag. Accordingly, the image decoding apparatus may obtain sps_explicit_scaling_list_enabled_flag encoded as an accurate value according to the present disclosure without determining whether no_scaling_list_constraint_flag is a first value (e.g., 1).

However, operation of the image decoding apparatus is not limited to the above example, and the image decoding apparatus may infer the value of sps_explicit_scaling_list_enabled_flag based on no_scaling_list_constraint_flag. For example, the image decoding apparatus may infer sps_explicit_scaling_list_enabled_flag as a second value (e.g., 0) when the value of no_scaling_list_constraint_flag is a first value (e.g., 1).

In addition, although not shown in FIG. 12, the image decoding apparatus may obtain no_scaling_list_constraint_flag from a bitstream. The image decoding apparatus may infer sps_explicit_scaling_list_enabled_flag as described above based on the obtained no_scaling_list_constraint_flag, and may efficiently perform initialization of the apparatus by including whether to apply a module related to the explicit scaling list. For example, the image decoding apparatus may initialize the apparatus such that used of the explicit scaling list is constrained based on no_scaling_list_constraint_flag, even when a current profile, tier and level allows use of the explicit scaling list. Therefore, more various encoding environments may be set.

FIG. 13 is a view illustrating an example of a syntax structure for signaling information specifying whether to constrain disabling of in-loop filtering at a virtual boundary as general constraint information of the present disclosure.

According to another embodiment of the present disclosure, constraint information of disabling of in-loop filtering at the virtual boundary may be signaled as general constraint information.

Referring to FIG. 13, information (e.g., no_virtual_boundaries_constraint_flag) specifying whether to constrain disabling of in-loop filtering at the virtual boundary may be signaled. In this case, information specifying whether to constrain disabling of in-loop filtering at the virtual boundary may be included and signaled in a general_constraint_info( ) syntax structure for signaling general constraint information.

According to the present embodiment, no_virtual_boundaries_constraint_flag of a first value (e.g., 1) may mean that a constraint is imposed such that sps_virtrual_boundaries_enabled_flag has a value of 0. In addition, no_virtual_boundaries_constraint_flag of a second value (e.g., 0) may mean that the constraint is not imposed. In the above, sps_virtrual_boundaries_enabled_flag is information signaled at a high level (e.g., SPS), and may be an example of information specifying whether in-loop filtering is disabled at the virtual boundary.

For example, sps_virtrual_boundaries_enabled_flag of a first value (e.g., 1) may specify that disabling of in-loop filtering at the virtual boundary is available for the CLVS, and sps_virtrual_boundaries_enabled_flag of a second value (e.g., 0) may specify that disabling of in-loop filtering at the virtual boundary is not available for the CLVS. When disabling of in-loop filtering at the virtual boundary is available, presence of the virtual boundary and/or information on the position of the virtual boundary may be additionally signaled and in-loop filtering may be performed based on presence of the virtual boundary. For example, when the boundary to be filtered is a virtual boundary, in-loop filtering may not be performed. When disabling of in-loop filtering at the virtual boundary is not available, presence of the virtual boundary and/or information on the position of the virtual boundary may not be additionally signaled and in-loop filtering may be performed without considering presence of the virtual boundary. For example, in-loop filtering may be performed without determining whether the boundary to be filtered is a virtual boundary. As described above, general constraint information may be included and signaled in a general_constraint_info( ) syntax structure. The general_constraint_info( ) syntax structure is present in a profile tier level (PTL) syntax structure, and information on additional constraints or restrictions for a specific profile, tier and level may be provided.

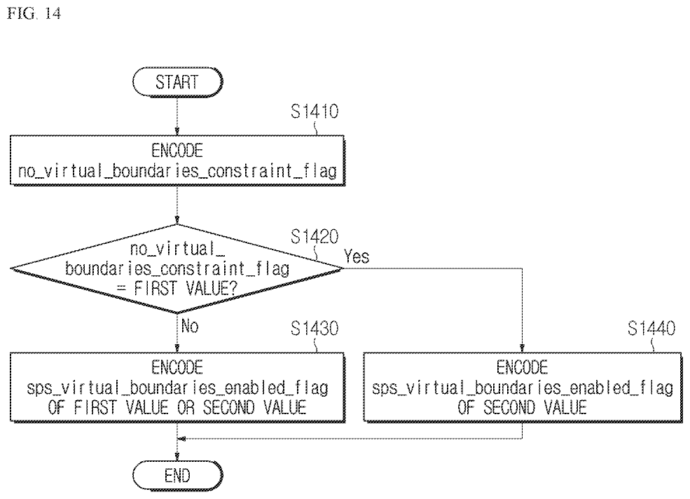

FIG. 14 is a view illustrating operation of the image encoding apparatus according to the embodiment described with reference to FIG. 13.

Referring to FIG. 14, the image encoding apparatus may encode no_virtual_boundaries_constraint_flag (S1410). The image encoding apparatus may determine whether to impose a constraint on disabling of in-loop filtering at the virtual boundary and encode no_virtual_boundaries_constraint_flag accordingly. When the constraint is imposed on disabling of in-loop filtering at the virtual boundary, the image encoding apparatus may encode no_virtual_boundaries_constraint_flag of a first value (e.g., 1). Alternatively, when the constraint is not imposed on disabling of in-loop filtering at the virtual boundary, the image encoding apparatus may encode no_virtual_boundaries_constraint_flag of a second value (e.g., 0). The image encoding apparatus may encode no_virtual_boundaries_constraint_flag as general constraint information in a general_constraint_info( ) syntax structure. For example, the image encoding apparatus may set constraint on disabling of in-loop filtering at the virtual boundary through signaling of no_virtual_boundaries_constraint_flag even when a current profile, tier and level disables in-loop filtering at the virtual boundary. Therefore, more various encoding environments may be set.

The image encoding apparatus determines the value of no_virtual_boundaries_constraint_flag (S1420), and, when the value is a second value (e.g., 0) (S1420-No), the image encoding apparatus may encode sps virtual boundaries enabled flag of a first value (e.g., 1) or a second value (e.g., 0) (S1430). When the value of no_virtual_boundaries_constraint_flag is a first value (e.g., 1) (S1420-Yes), the image encoding apparatus may encode sps virtual boundaries enabled flag of a second value (e.g., 0) (S1440). The image encoding apparatus may encode, for example, sps virtual boundaries enabled flag in the SPS.

When sps_virtual_boundaries_enabled_flag is a first value (e.g., 1), the image encoding apparatus may encode additional information related to a virtual boundary (not shown). When sps_virtual_boundaries_enabled_flag is a second value (e.g., 0), the image encoding apparatus may skip signaling of the additional information related to the virtual boundary (not shown). The image encoding apparatus may enable or disable in-loop filtering at the virtual boundary based on sps_virtual_boundaries_enabled_flag and/or the additional information related to the virtual boundary, thereby performing encoding with respect to a current picture included in a current sequence.

FIG. 15 is a view illustrating operation of the image decoding apparatus according to the embodiment described with reference FIG. 13.

Referring to FIG. 15, the image decoding apparatus may obtain sps_virtual_boundaries_enabled_flag from a bitstream (S1510). In this case, sps_virtual_boundaries_enabled_flag may be encoded by the method described with reference to FIG. 14.

The image decoding apparatus may determine whether sps_virtual_boundaries_enabled_flag is a first value (e.g., 1) (S1520). When sps_virtual_boundaries_enabled_flag is a first value (e.g., 1) (S1520-Yes), the image decoding apparatus may perform parsing of the additional information related to the virtual boundary (S1540). In this case, the image decoding apparatus may reconstruct a current picture by disabling in-loop filtering at the virtual boundary, based on the additional information related to the virtual boundary (not shown). When sps_virtual_boundaries_enabled_flag is a second value (e.g., 0) (S1520-No), the image decoding apparatus may skip parsing of the additional information related to the virtual boundary (S1530). In this case, the image decoding apparatus may reconstruct a current picture (not shown) by performing in-loop filtering without considering the virtual boundary.

sps_virtual_boundaries_enabled_flag received by the image decoding apparatus is encoded by the method described with reference to FIG. 14. That is, the image decoding apparatus receives sps_virtual_boundaries_enabled_flag encoded by the image encoding apparatus based on no_virtual_boundaries_constraint_flag. Accordingly, the image decoding apparatus may obtain sps_virtual_boundaries_enabled_flag encoded as an accurate value according to the present disclosure, without determining whether no_virtual_boundaries_constraint_flag is a first value (e.g., 1).

However, operation of the image decoding apparatus is not limited to the above example, and the image decoding apparatus may infer the value of sps_virtual_boundaries_enabled_flag based on no_virtual_boundaries_constraint_flag. For example, the image decoding apparatus may infer sps_virtual_boundaries_enabled_flag as a second value (e.g., 0) when the value of no_virtual_boundaries_constraint_flag is a first value (e.g., 1).

In addition, although not shown in FIG. 9, the image decoding apparatus may obtain no_virtual_boundaries_constraint_flag from the bitstream. The image decoding apparatus may infer sps_virtual_boundaries_enabled_flag based on the obtained no_virtual_boundaries_constraint_flag as described above, and may efficiently perform initialization of the apparatus by including whether to apply a module related to disabling of in-loop filtering at the virtual boundary. For example, the image decoding apparatus may initialize the apparatus such that disabling of in-loop filtering at the virtual boundary is constrained based on no_virtual_boundaries_constraint_flag even when a current profile, tier and level allows disabling of in-loop filtering at the virtual boundary. Therefore, more various encoding environments may be set.

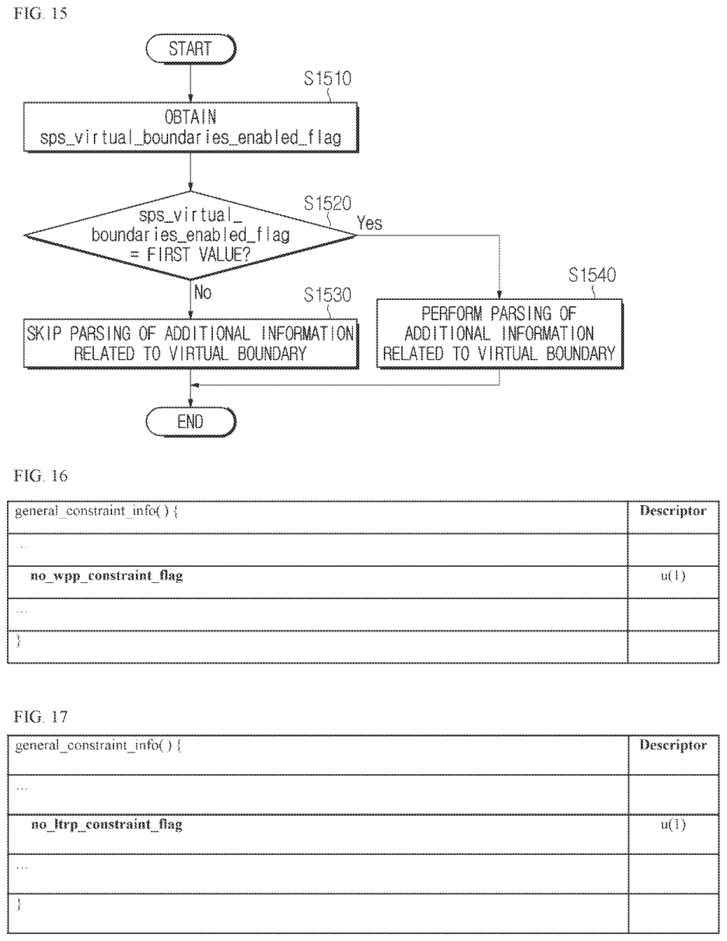

FIG. 16 is a view illustrating an example of a syntax structure for signaling information specifying whether to constrain entropy coding synchronization as general constraint information of the present disclosure.

According to another embodiment of the present disclosure, constraint information of performance of a specific process of synchronizing and storing a context variable for entropy coding may be signaled as general constraint information.

Referring to FIG. 16, information (e.g., no_wpp_constraint_flag) indicating whether a specific synchronization process and a specific storage process for the context variable are constrained may be signaled. In this case, the information specifying whether to constrain the specific synchronization process and the specific storage process may be included and signaled in a general_constraint_info( ) syntax structure for signaling general constraint information.

According to the present embodiment, no_wpp_constraint_flag of a first value (e.g., 1) may mean that a constraint is imposed such that sps entropy coding sync enabled flag has a value of 0. In addition, no_wpp_constraint_flag of a second value (e.g., 0) may mean that the constraint is not imposed. In the above, sps entropy coding sync enabled flag is information signaled at a high level (e.g., SPS), and may be an example of information specifying whether to constrain the specific synchronization process and the specific storage process for the context variable.

For example, sps_entropy_coding_sync_enabled_flag of a first value (e.g., 1) may specify that the specific synchronization process for the context variable is called before decoding a coding tree unit (CTU) including a first CTB of a coding tree block (CTB) row in each tile in each picture referencing the SPS. sps_entropy_coding_sync_enabled_flag of a first value (e.g., 1) may specify that the specific storage process for the context variable is called after decoding the coding tree unit (CTU) including the first CTB of the coding tree block (CTB) row in each tile in each picture referencing the SPS. sps_entropy_coding_sync_enabled_flag of a second value (e.g., 0) may specify that the specific synchronization process for the context variable is not called before decoding the coding tree unit (CTU) including the first CTB of the coding tree block (CTB) row in each tile in each picture referencing the SPS. In addition, sps_entropy_coding_sync_enabled_flag of a second value (e.g., 0) may specify that the specific storage process for the context variable is not called after decoding the coding tree unit (CTU) including the first CTB of the coding tree block (CTB) row in each tile in each picture referencing the SPS. As described above, general constraint information may be included and signaled in a general_constraint_info( ) syntax structure. The general_constraint_info( ) syntax structure is present in a profile tier level (PTL) syntax structure, and information on additional constraints or restrictions for a specific profile, tier and level may be provided.

FIG. 17 is a view illustrating an example of a syntax structure for signaling information specifying whether to constrain use of a long term reference picture (LTRP) as general constraint information of the present disclosure.

According to another embodiment of the present disclosure, constraint information of use of the LTRP may be signaled as general constraint information.

Referring to FIG. 17, information (e.g., no_ltrp_constraint_flag) specifying whether to constrain use of the LTRP may be signaled. In this case, the information specifying whether to constrain use of the LTRP may be included and signaled in a general_constraint_info( ) syntax structure for signaling general constraint information.

According to the present embodiment, no_ltrp_constraint_flag of a first value (e.g., 1) may mean that a constraint is imposed such that sps_long_term_ref_pics_flag has a value of 0. In addition, no_ltrp_constraint_flag of a second value (e.g., 0) may mean that the constraint is not imposed. In the above, sps_long_term_ref_pics_flag is information signaled at a high level (e.g., SPS) and may be an example of information specifying whether to constrain use of the LTRP.

For example, sps_long_term_ref_pics_flag of a first value (e.g., 1) may specify that the LTRP may be used for inter prediction of one or more coded picture in the CLVS, and sps_long_term_ref_pics_flag of a second value (e.g., 0) may specify that the LTRP is not used for inter prediction of one or more coded picture in the CLVS. As described above, general constraint information may be included and signaled in a general_constraint_info( ) syntax structure. The general_constraint_info( ) syntax structure is present in a profile tier level (PTL) syntax structure, and information on additional constraints or restrictions for a specific profile, tier and level may be provided.

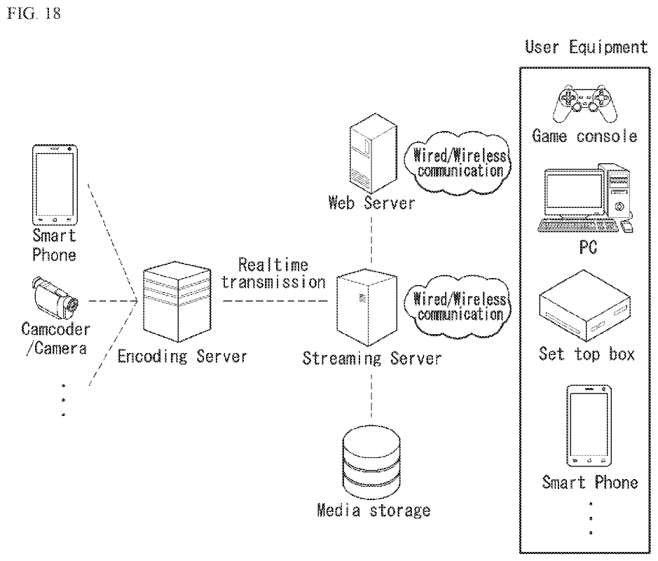

FIG. 18 is a view showing a content streaming system, to which an embodiment of the present disclosure is applicable.

As shown in FIG. 18, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
obtaining first information specifying whether to constrain application of a predetermined coding tool;
obtaining second information specifying whether to apply the predetermined coding tool; and
reconstructing a current picture based on the second information,
wherein a value of the second information is determined based on a value of the first information, and
wherein the predetermined coding tool comprises at least one of weighted prediction, explicit signaling of a scaling list for a transform coefficient or disabling of in-loop filtering at a virtual boundary.

2. The image decoding method of claim 1, wherein the second information has a value specifying that the predetermined coding tool is not applied, based on the first information specifying that application is constrained.

3. The image decoding method of claim 1, wherein the first information is obtained from a syntax structure for signaling general constraint information.

4. The image decoding method of claim 1, wherein the second information is obtained from a sequence parameter set (SPS).

5. (canceled)

6. An image encoding method performed by an image encoding apparatus, the image encoding method comprises:
encoding first information specifying whether to constrain application of a predetermined coding tool;
encoding second information specifying whether to apply the predetermined coding tool; and
encoding a current picture in a current video sequence based on the second information,
wherein a value of the second information is determined based on a value of the first information, and
wherein the predetermined coding tool comprises at least one of weighted prediction, explicit signaling of a scaling list for a transform coefficient or disabling of in-loop filtering at a virtual boundary.

7. The image encoding method of claim 6, wherein the second information has a value specifying that the predetermined coding tool is not applied, based on the first information specifying that application is constrained.

8. The image encoding method of claim 6, wherein the first information is encoded in a syntax structure for signaling general constraint information.

9. The image encoding method of claim 6, wherein the second information is encoded in a sequence parameter set (SPS).

10. A non-transitory computer-readable recording medium storing a bitstream generated by the image encoding method of claim 6.

11. A method of transmitting a bitstream generated by an image encoding method, the image encoding method comprising:
encoding first information specifying whether to constrain application of a predetermined coding tool;
encoding second information specifying whether to apply the predetermined coding tool; and
encoding a current picture in a current video sequence based on the second information,
wherein a value of the second information is determined based on a value of the first information, and
wherein the predetermined coding tool comprises at least one of weighted prediction, explicit signaling of a scaling list for a transform coefficient or disabling of in-loop filtering at a virtual boundary.
